(19) United States
(12) Patent Application Publication
(10) Pub. No.: US 2008/0301807 A1
(43) Pub. Date: Dec. 4, 2008

(54) System and Method for Controlling On-Demand Security

(76) Inventors: Ellis E. Bishop, Austin, TX (US); Randy S. Johnson, O'Fallon, MI (US); Linda D. Kalmes, Loveland, CO (US); Gary Little, Apex, NC (US); Tedrick N. Northway, Wood River, IL (US); H. William Rinckel, Prospect, CT (US); Samuel R. Thennis, Longmont, CO (US)

Correspondence Address: IBM CORPORATION (AUS);c/o Rudolf O Siegesmund Yee & Associates, P.C., P.O. Box 802333, DALLAS, TX, 75380, US

(21) Appl. No.: 12/177,374

(22) Filed: Jul. 22, 2008

Related U.S. Application Data
(63) Continuation of application No. 11/191,619, filed on Jul. 28, 2005.

(51) Int. Cl. G06F 12/14

(52) U.S. Cl. 726/22

(57) ABSTRACT

An on-demand security service ensures isolation of the service provider's customers where the customers share resources at the system, subsystem, and storage level. The security service is provided in a pre-production phase and in a post production phase. The pre-production phase takes place prior to boarding the customer. In the pre-production phase the resources to be protected are defined in a security guide, and using the security guide, physical segregation at the facility, network, and technical and delivery support levels is planned and then implemented. In the post production phase, on going activities are proactive and reactive. Proactive activities include maintaining physical segregation by reviewing and updating the security guide, and testing physical segregation by performing security audits and penetration tests. Observations and finding of the audits and penetration tests are resolved. Reactive activities include identifying isolation failures, coordinating appropriate actions, and resolving the isolation failure. The service may be embodied in a system and in a computer implemented process comprising a security guide file (SGF), a security guide application (SGA), a security implementation application (SIA), a security validation application (SVA), and an event coordination application (ECA).

### CROSS-REFERENCE TO RELATED APPLICATION(S)

This application is a continuation application of co-pending U.S. utility patent application entitled “System and Method for Controlling On-Demand Security” filed on Jul. 28, 2005, and accorded Ser. No. 11/191,619, and claims priority therefrom.

### FIELD OF THE INVENTION

The present invention relates generally to security support for electrical computers and digital processing systems, and specifically to providing security by isolation of multiple customers in an on-demand operating system environment.

### BACKGROUND OF THE INVENTION

For many years, information technology (IT) organizations (the “providers”) have offered IT management services and computing resources to other business entities (the “customers”). In a “traditional” service model, the customers share a provider's management services, but each customer purchases or leases specific resources for the customer's exclusive benefit. The customer may purchase or lease the resources directly from the provider or from a third party. Regardless of their origins, though, such a purchase or lease may require extensive, time-consuming negotiations based upon the customer's anticipated requirements. If the customer's requirements are less than anticipated, then the customer effectively has wasted resources. If, however, the customer's requirements are greater than anticipated, then the customer may have to enter into additional time-consuming negotiations for the necessary resources.

Alternatives to the traditional service model, though, are able to anticipate and meet customers' processing needs as their requirements grow, while maximizing existing resources. One such alternative pioneered by International Business Machines Corp. allows a service provider to allocate resources to customers “on-demand” as the customers' needs change. In this on-demand service model, customers share computing and networking resources. In one implementation of the on-demand model, a service provider creates “logical” partitions of computing resources on primary processing units (commonly known as “mainframe” computers). Typically, an on-demand service provider contracts with several customers to provide a certain level of service to each customer, and creates a logical partition (LPAR) of resources for each customer to fulfill its obligations. Unlike traditional service contracts, an on-demand service contract generally requires that the customer be billed only for resources actually used, and for fixed costs not directly related to usage (such as labor costs incurred in support of the contract).

Generally, the on-demand provider delivers services based upon a contract that allows a variance of utilization. The provider delivers the requested services without regard to the physical resources used to provide those services. The customer does not purchase or lease the physical resources; instead, the provider retains the discretion to allocate the resources to logical partitions as needed to meet its service obligations. Typically, the provider establishes threshold levels of service that guide dynamic allocation of resources. Although on-demand customers may share a provider's services and computing resources, the provider generally must segregate and protect each customer's data.

In an on-demand data center, software is shared, simultaneously serving multiple customers in a flexible, automated fashion. The software is standardized, requiring little customization, and it is scalable, providing capacity on demand in a pay-as-you-go model. The software can be stored on a shared file system accessible from one or more servers. The software is executed via transactions that contain data and server processing requests that use processing resources on the accessed server. The accessed server also may make requests of other servers that require the use of processing resources. The use or consumption of processing resources is measured in units of time such as minutes, seconds, or hours. A CPU is one example of a processing resource, but other resources that may be consumed and measured include (but are not limited to) network bandwidth, memory, storage, packet transfers, complete transactions, etc.

When multiple customers use the same software application, their transactions are differentiated by the parameters included in the transactions that identify the unique customer and the type of service for that customer. All of the processing units and other measurements of use that are used for the services for each customer are recorded. When the number of transactions to any one server reaches a number that begins to affect the performance of that server, other servers are accessed to increase the capacity and to share the workload. Likewise, when the number of transactions approaches the capacity limits of other processing resources, additional resources such as network bandwidth, memory or storage are added to share the workload.

Customers of “on-demand” services share the provider's management services and computing resources (to the system and subsystem level), including persistent memory (“storage”), volatile memory (“memory”); and processors. “On-demand” service providers enable several customers to share the same computational resources, both at the processor (or system) level and at the subsystem level. Additionally, DASD, tape, and network resources are shared. Controlling IT security within this environment brings forth new challenges such as protecting customer data in shared environments that haven't previously been shared and ensuring appropriate customer access while protecting against unexpected intrusions from other customers or intruders. As such, a need arises for a comprehensive method for managing IT security on servers with shared CPU and disk storage.

Traditional methods of providing IT security include architectures to determine whether an application can be trusted (United States Publication 2003/0041267), to monitor a defined target such as a premise (U.S. Pat. No. 6,542,075), and to aggregate and to make a determination what to load or block (United States Publication 2004/0230835). United States Publication 2005/0033991 (the '991 publication) discloses a method to evaluate security within a data processing or transactional environment. In the '991 publication method, the data processor interrogates the transactional environment to determine what devices or applications exist within the environment and their operating state. The data processor then evaluates the data and provides an indication of the trust that can be placed in the environment. The above described methods of providing and evaluating IT security are directed toward the “traditional” service model. However, these methods do not address the need of the on-demand service environment where multiple customers share the provider's management services and computer resources.

Therefore, a need exists for an apparatus and method to provide security protection of logical and physical inventory and assets associated with the delivery of the on-demand services.

### SUMMARY OF THE INVENTION

An on-demand security service ensures isolation of the service provider's customers where the customers share resources at the system, subsystem, and storage level. The security service is provided in a pre-production phase and in a post production phase. The pre-production phase takes place prior to boarding the customer. In the pre-production phase the resources to be protected are defined in a security guide; and using the security guide, physical segregation at the facility, network, and technical and delivery support levels is planned and then implemented. In the post production phase, on going activities are proactive and reactive. Proactive activities include maintaining physical segregation by reviewing and updating the security guide, and testing physical segregation by performing security audits and penetration tests. Observations and finding of the audits and penetration tests are resolved. Reactive activities include identifying isolation failures, coordinating appropriate actions, and resolving the isolation failure. The service may be embodied in a system and in a computer implemented process comprising a security guide file (SGF), a security guide application (SGA), a security implementation application (SIA), a security validation application (SVA), and an event coordination application (ECA).

These and other objects of the invention will be apparent to those skilled in the art from the following detailed description of a preferred embodiment of the invention.

### BRIEF DESCRIPTION OF DRAWINGS

The novel features believed characteristic of the security service are set forth in the appended claims. The security service itself, however, as well as a preferred mode of use, further objectives and advantages thereof, will be understood best by reference to the following detailed description of an illustrative embodiment when read in conjunction with the accompanying drawings, wherein:

FIG. 1 illustrates an overview of a Service Oriented Architecture for an on-demand operating environment;

FIG. 2 illustrates an example of an on-demand service configuration;

FIG. 3A is an overview of the on-demand security service;

FIG. 3B is an overview of the on-demand security service;

FIG. 4 is an illustration of an on-demand security service system software component configuration;

FIG. 5 is a flow chart of the security guide application;

FIG. 6 is a flow chart of the security implementation application;

FIG. 7 is a flow chart of the security validation application; and

FIG. 8 is a flow chart of the event coordination application.

### DETAILED DESCRIPTION OF THE PREFERRED EMBODIMENT

The on-demand operating environment of the present invention is based upon the concepts of a service oriented architecture (SOA), In an SOA, every application or resource is modeled as a service that implements a specific, identifiable function (or set of functions). In an on-demand environment, the services often implement specific business functions, but also may implement interfaces or other operating functions.

Services in SOAs communicate with each other by exchanging structured information, typically through messages or documents. The services' capabilities are defined by interfaces declaring messages they can produce or consume, policy annotations declaring a quality of service required or provided, and choreography annotations declaring behavioral constraints that must be respected in service interactions. The actual implementation of any specific service is hidden from the service requester, which allows new and existing applications to be quickly combined into new contexts.

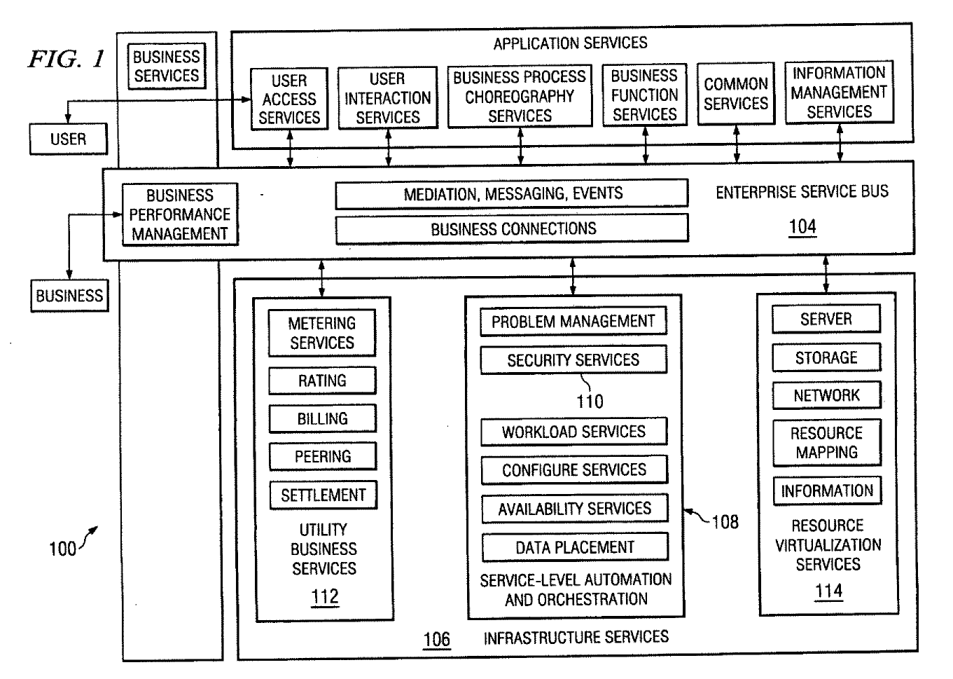

FIG. 1 provides an overview of SOA 100. At the system level, components of the environment are system objects such as servers, storage, and data. At the application level, components are dynamically integrated application modules that constitute sophisticated, yet much more flexible applications. At the business level, the components are business objects, defined for particular vertical industries or more generally, as they apply horizontally across industries.

Typically, a specific on-demand business service relies on many other services in its implementation. All interactions between services flow through an Enterprise Service Bus (ESB) such as ESB 104. ESB 104 facilitates mediated interactions between service end points. ESB 104 supports event-based interactions, as well as message exchange for service request handling. For both events and messages, mediations can facilitate interactions by, for example, locating services that provide requested capabilities, or by handling interface mismatches between requesters and providers that are compatible in terms of their capabilities.

Infrastructure services 106 include service-level automation and orchestration 108, utility business services 112, and resource virtualization services 114. Service-level automation and orchestration 108 includes security services 110. Security services 110 address, inter alia, customer isolation in the on-demand operating system environment.

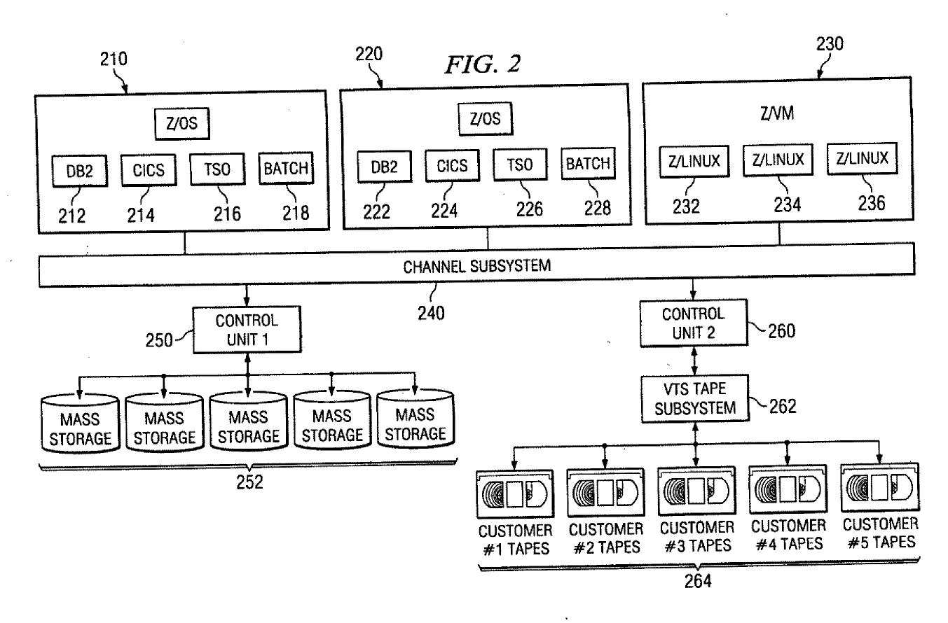

FIG. 2 depicts a high level view of one on-demand platform configuration requiring security at the system, subsystem, and storage level. The on-demand operating environment is presented as an example to demonstrate segregation issues encountered in an on-demand environment. These segregation issues involve configuration and control of the system. The on-demand operating environment of FIG. 2 has three logical partitions, LPAR 1 210, LPAR 2 220 and LPAR 3 230, connected to channel subsystem 240. Channel subsystem 240 is connected to control unit 1 250 and control unit 2 260. Control unit 1 250 is connected to plurality of mass storage 252. Second control unit is connected to VTS Tape Subsystem (Tape) 262. Tape 262 is connected to customer tapes 264 (customer tapes 1-5).

Multiple customers may share the resources of LPAR 1 210, LPAR 2 220, and LPAR 3 230. LPAR1 210 and LPAR2 220 have Z/OS running on a Z series processor, and LPAR 3 230 has z/VM and AIX operating systems executing on IBM P series processor. LPAR 1 210 has a Z/OS operating system, DB2 212, Customer Information Control System (CICS) 214, Time Sharing Option (TSO) 216 and Batch 218. LPAR 220 has a z/OS operating system, DB2 222, Customer Information Control System (CICS) 224, Time Sharing Option (TSO) 226 and Batch 228. Each processor and operating system configuration presents a different segregation issue. In order to ensure that each client will be isolated, the Z series processor running z/OS requires that LPAR1 210 and LPAR2 220 and data-sharing roles be specifically defined to ensure client isolation. For example, LPAR 1 210 and LPAR 2 220 may be defined with hard capping to prevent one customer from impacting another customer's processor usage. On the other hand, in LPAR 3 230, the P series processors running AIX each have their own individual LPAR which cannot impact other customers. But software can allow dynamic adjustment of customers CPU utilization across LPAR 3 230 and therefore, such CPU usage must be defined to prevent one customer's CPU utilization from impacting another customer's CPU utilization.

Multiple customers may share subsystems within an LPAR. For example, LPAR 3 may have three customers, each running their own separate zLinux subsystems, z/Linux 232, z/Linux 234, and z/Linux 236. The hardware and the system software must be designed to accept the incoming customer at boarding. Additionally, the hardware and the system software must be monitored during production so that if a customer needs additional resources, the customer's segregation can be altered accordingly.

Control units must be configured to ensure that one customer will not intrude upon another customer's storage. In the example system of FIG. 2, multiple customers may access disk storage through control unit 1 250. One method by which Control unit 1 may isolate a customer is through the use of dynamic parallel access volumes (PAVs). But PAVs are managed at the subsystem level, and not at the operating system level. Therefore, LPAR 1 210, LPAR 2 220, and LPAR 3 230 cannot access a dynamic parallel access volume (PAV) through control unit 1, 250 unless control unit 1 250 has been configured to permit the access. Moreover, when a customer having a static PAV is to be boarded, client isolation requires a specific design of workload management PAV parameters to allow the usage of dynamic PAVs without sharing of the Logical Control Units (LCU).

Referring to FIG. 2, the example on-demand system has Virtual Tape Subsystem (VTS) 262 with individual customer tapes 264. Since an on-demand customer cannot share a physical tape with another customer, tape isolation is controlled by customizing the tape management catalog system or, alternatively, by assigning a specific volume serial number range to a customer.

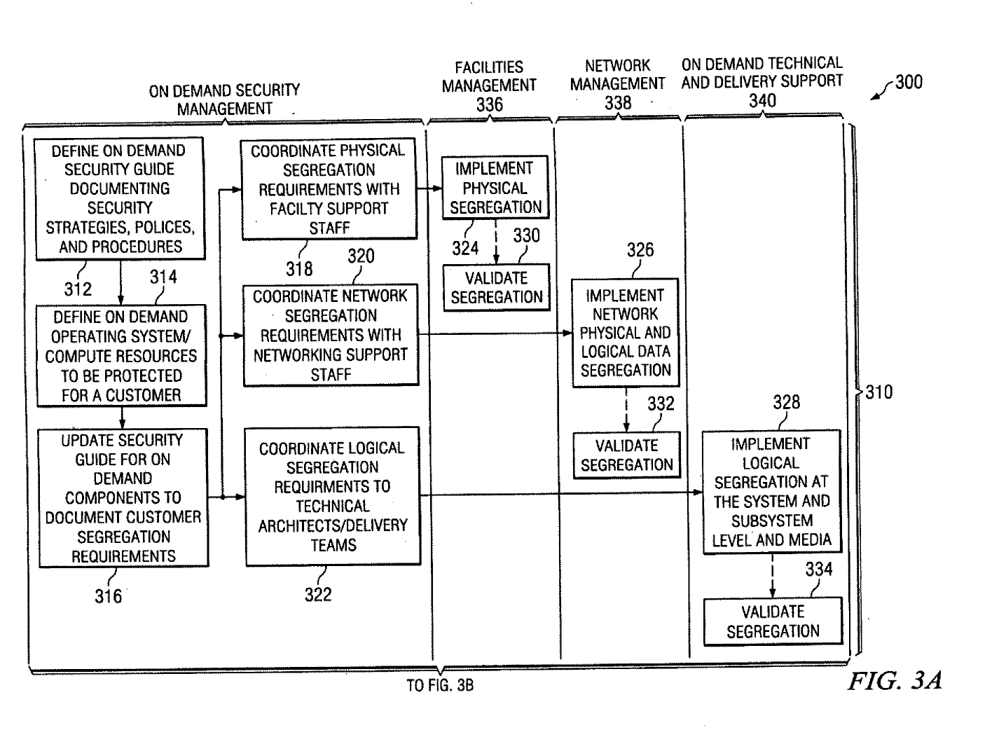

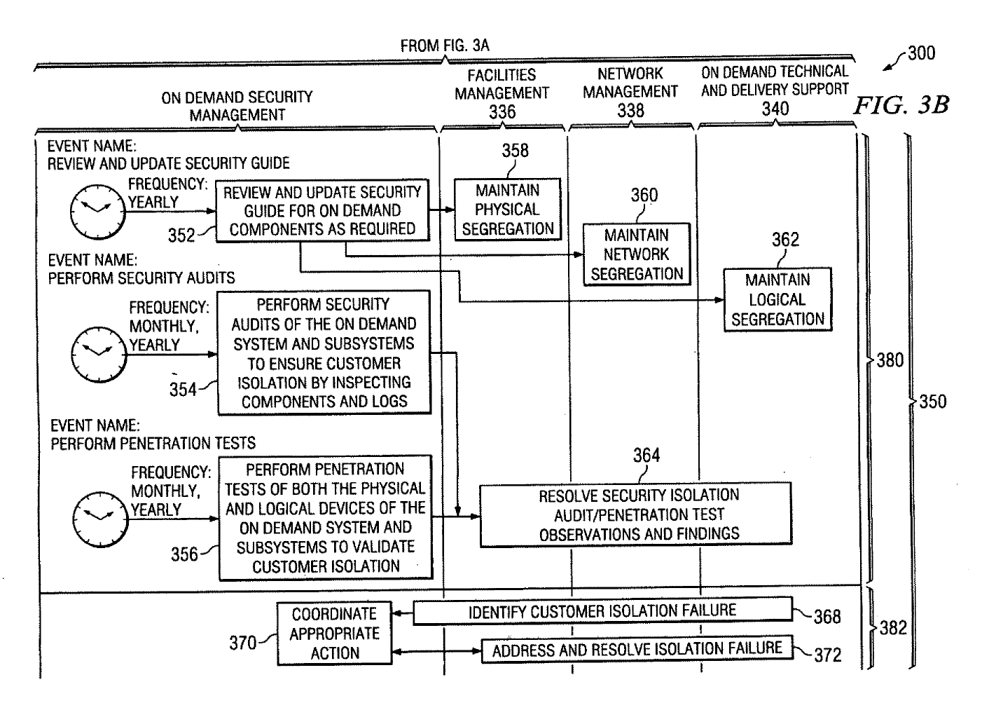

FIG. 3A and FIG. 3B depict an overview of on-demand security service (SS) 300 that ensures isolation of the service provider's customers where the customers share resources at the system, subsystem, and storage level. SS 300 performs in a pre-production phase 310 and in a post production phase 350. Pre-production phase 310 takes place prior to boarding the customer. In pre-production phase 310, the resources to be protected are defined in a security guide, and using the security guide, physical segregation at the facility, network, and technical and delivery support levels is planned and then implemented. In post production phase 350, on going activities are of two types: proactive activities 380 and reactive activities 382. Proactive. activities 380 include maintaining physical segregation by reviewing and updating the security guide, testing physical segregation by performing security audits and penetration tests, and resolving observations and finding of the audits and penetration tests. Reactive activities 382 include identifying isolation failures, coordinating appropriate actions, and resolving the isolation failure.

The steps to be performed in pre-production phase 310 may be categorized as follows: planning, implementation, and testing. Planning includes defining the on-demand operating system computational resources to be protected for a customer (314), updating the security guide for the defined on-demand operating system components to document customer segregation requirements for the customer and including the isolation standards and requirements to achieve the standards in the documentation, and specifying in the security guide how to ensure customer segregation for each component (316). Components include processors, DASD devices, tape devices, media storage, network addresses and devices, and shared subsystems such as DB2.

Planning takes place during customer solution design and includes the following steps: coordinating physical segregation requirements with facility support staff (318), coordinating network segregation requirements with networking support staff (320), and coordinating logical segregation requirements to technical architects and delivery teams (322).

Implementation takes place during customer boarding and involves facilities management 336, network management 338, and technical and delivery support management 340.

Facilities management 336 uses the security guide to implement the physical segregation requirements established by the security guide for the customer (324). The security guide includes regulations that govern the access to a computing facility by physical means. For example, an entrance to a facility may be protected by a security guard, and access to data or data files by physical means may be protected by' tape library restrictions. The security guide addresses both physical access control coordination, and physical data control coordination. In some instances, physical control may be performed externally to the on demand system. In such an event, security service 300 would interface with the appropriate parties to ensure that controls are in place.

Network management 338 uses the security guide to implement physical and logical data segregation (326). Network, security controls for voice and data networks include implementing physical voice controls, implementing logical voice controls, implementing logical data controls, implementing network gateway control, and implementing mobile terminal logical access controls.

Technical and delivery support 340 management implements and validates logical segregation at the system and subsystem level and media level (328). Logical data separation at the system and subsystem level is controlled by controlling access. Access is controlled by identifying and authenticating users, defining and classifying resources to be protected, defining and validating users that need access to platform-provided security mechanisms, granting “privileged” access rights, ensuring that a security and integrity advisory process is implemented, ensuring that user administration procedures meet on demand configuration IT security requirements, approving access based on business need, and revalidating the need for access on a periodic basis.

Implementation of segregation at the media level involves requirements that govern hand transportable media such as disks and tapes. Media requirements include establishing media inventory and tracking, classifying and declassifying media as required, physical protection of the media for external or non-authorized parties, removal and protection of the media when leaving the on demand configuration environment data removal and media disposal.

Testing takes place to validate client isolation prior to production customer use. The security guide is also used to validate segregation at the facilities (330), network (332), and system, subsystem levels and media levels (334).

The steps to be performed in post production phase 350 can be categorized as proactive activities 380 or reactive activities 382. Proactive steps include reviewing the security guide to ensure that any new components are supported, and that changes to support new requirements are implemented (352), and maintaining physical segregation at the facility level (358), the network level (360), and the technical and delivery support level (362). Proactive activities 380 steps further include: performing security audits (354) and performing penetration tests (356). Specific responsibilities include performing periodic reviews of the guide based on account-specific criteria such as a specified time frame, a major technology change, a change in customer requirements, a change in facility environment, and a security guideline change.

Security service 300 performs security audits of the on-demand system and sub-systems to validate proper implementation of the security guide to ensure customer isolation. Audits are conducted by inspecting components and logs (354). Security service 300 resolves security isolation audit observation and findings (364).

Security service 300 performs penetration tests of both the physical and logical devices of the on-demand system and subsystems to validate proper implementation of the security guide and to ensure customer isolation (356). Security service 300 resolves penetration test observations and findings (364).

Reactive activities 382 steps include identifying customer isolation failure (368), coordinating appropriate action (370), and addressing and resolving isolation failure (372). Reactive activities 382 also includes reviewing, and if necessary, modifying the IT security guide based on specific incidents or risks, managing security incidents and issues, performing peer and self assessments, performing systems assurance reviews, reviewing audit results, monitoring system misuse, ensuring that systematic incidents can be detected, creating incident and issue records, maintaining a physical access list for secure rooms and areas, interfacing with site facilities for support of physical access control systems (for example, card readers and alarms), approving or rejecting access requests (and notifying the requester of the approval or rejection), and performing periodic reviews and validation of access control list(s), performing periodic reviews and validation of physical access control systems. Reactive steps further include ensuring that physical security access requirements are met when these are maintained or controlled by another party, but where delivery of services could be affected.

The security guide documents the strategies, policies and procedures to manage customer data separation and confidentiality in the on-demand operating environment (312). For each customer's defined computational resources that are to be protected, rules and practices are specified to ensure that customer's isolation in the on-demand operating environment. The rules and practices are developed by first, defining the on demand operating system resources to be protected for a customer (314), and then documenting the customer's segregation requirements (316). Next, the security guide provides requirements for coordinating physical segregation requirements with facility support staff (318), for coordinating network segregation requirements with networking support staff (320), and for coordinating logical segregation requirements to technical architects and service delivery teams (322). The security guide provides requirements at the facility level for implementing physical security and for validating physical segregation. The security guide provides requirements at the network level for implementing and validating physical and logical data segregation. The security guide provides requirements for on-demand and technical delivery support security by implementing and validating logical segregation at the system and subsystem level and media level.

Security service 300 may be embodied in a computer-implemented process and computer program product comprising a security guide file (SGF), a security guide application (SGA), a security implementation application (SIA), a security validation application (SVA), and an event coordination application (ECA).

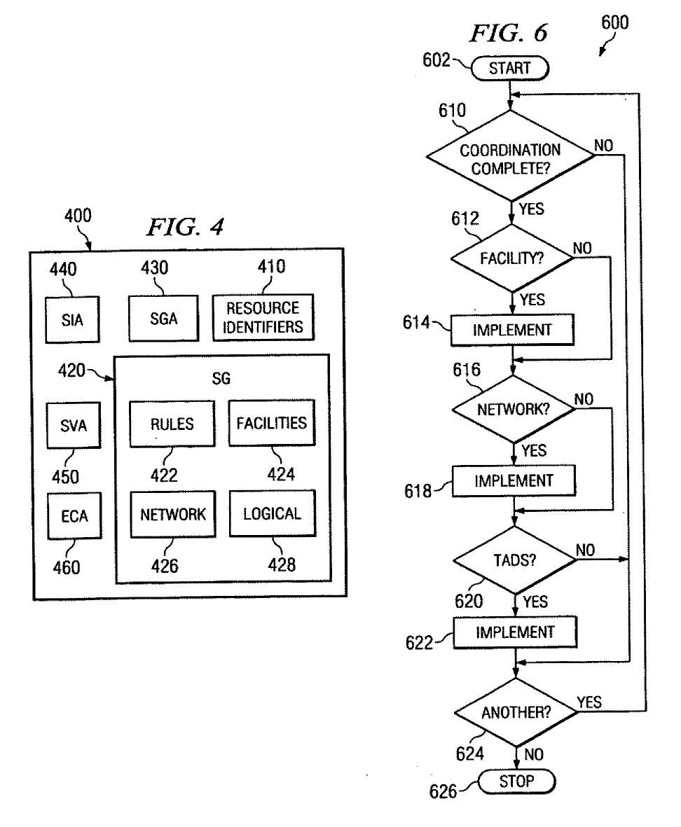

FIG. 4 depicts storage 400 containing files and software of a computer implemented embodiment of security service 300 (see FIG. 3). Storage 400 may be located with resources associated with security services 110 of SOA 100 (see FIG. 1), or may be distributed within a service provider's resources (not shown). Storage 400 contains resource identifiers 410, security guide file 420, security guide application 430, security implementation application 440, security validation application 450, and event coordinator application 460.

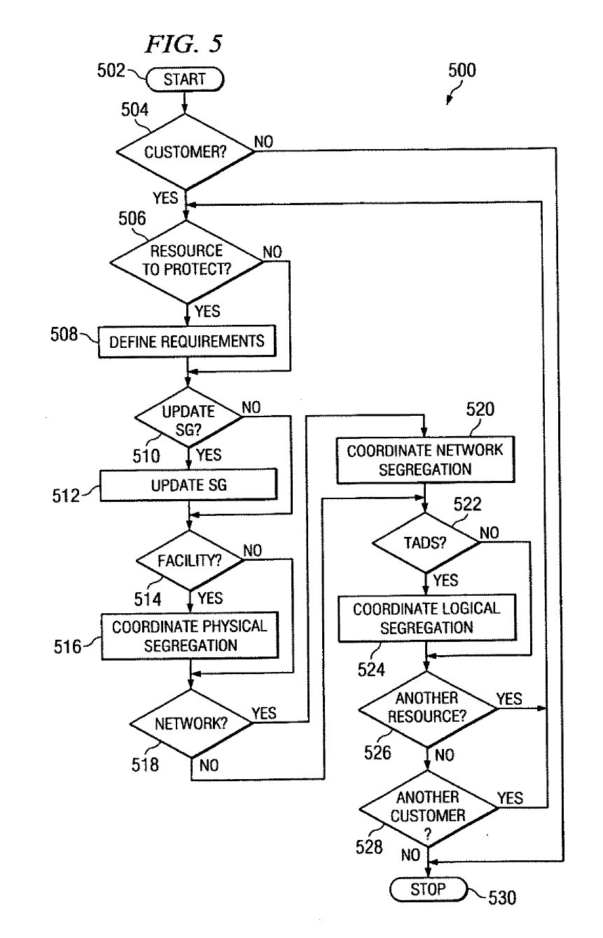

FIG. 5 depicts a flow chart of security guide application (SGA) 500. SGA 500 begins (502) and determines whether services are to be provided to a customer (504). One way in which such information may be electronically available is that one or more potential service contracts are accessed. If so, SGA 500 determines whether the customer has resources to protect (506). If so, SGA 500 defines the requirements (508). Such definition could be made by accessing the security guide for a pre-determined set of requirements based on the resource to be protected, or alternatively, SGA 500 could prompt the user to enter the requirements. If there is no customer resource to protect, or after the requirements are defined, SGA 500 determines whether SG 420 (see FIG. 4) should be updated. If a new resource has been defined, then SG 420 would be updated (512). SGA 500 determines whether there is a facility to provide security (514). If so, SGA 500 coordinates the physical segregation (516). SGA 500 determines whether there is a network for which to provide security (518). If so, SGA 500 coordinates network segregation (520). SGA 500 determines whether technical and delivery support requires coordination (522). If so, SGA coordinates logical segregation (524). SGA 500 determines whether there is another resource to process (526). If so, SGA 500 goes to step 506. If not, SGA 500 determines whether there is another customer to process (528). If so, SGA 500 goes to step 506, and if not, SGA 500 stops (530).

FIG. 6 is a flow chart of security implementation application (SIA) 600. SIA 600 starts (602) and determines whether coordination has been completed (610). If so, SIA 600 determines whether there is a facility to implement, and if so, implements the requirements for physical isolation of the customer (614). SIA 600 determines whether there is network to implement (616) and if so, implements the physical and logical requirements for the network (618). SIA 600 determines whether technical and delivery support is to be implemented (620), and if so, implements the logical requirements (622). SIA 500 determines whether there is another customer to implement (624), and if not, SIA 500 stops (626).

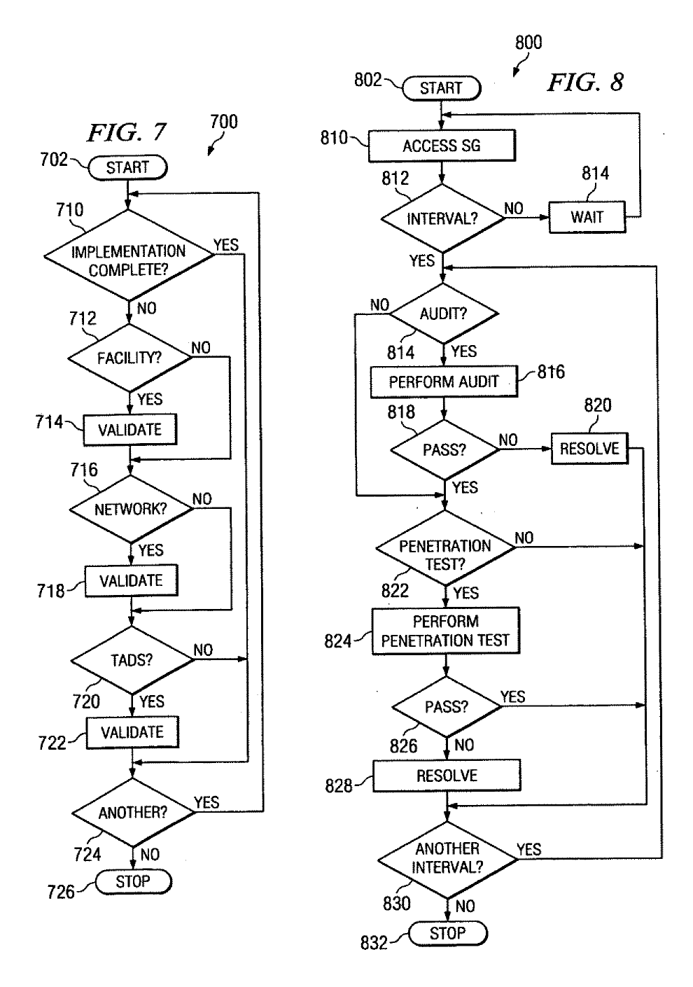

FIG. 7 is a flow chart of security validation application (SVA) 700. SVA 700 starts (702) and determines whether implementation has been completed (710). If so, SVA 700 determines whether there is a facility to validate (712) and if so, validates the requirements for physical isolation of the customer (714). SVA 700 determines whether there is a network to implement (716) and if so, validates the physical and logical requirements for the network (718). SVA 700 determines whether technical and delivery support is to be validated (720), and if so, validates the logical requirements (722). SVA 700 determines whether there is another customer to implement (724), and if not, SVA 700 stops (726).

FIG. 8 is a flow chart of the logic of the event coordination application (ECA) 800. ECA 800 starts (802) and accesses the security guide (810). ECA 800 determines whether an interval specified in the security guide for execution of an action has elapsed (812). If not, ECA 800 waits (813) and goes to step 810. If so, ECA 800 determines whether an audit is to be performed (814). If so the audit is performed (816) and a determination is made where the customer passed the audit (818). If not, the audit is resolved (820). ECA 800 determines whether a penetration test is to be performed (822). If so, the penetration test is performed (824) and a determination is made whether the resources passed the test (826). If not, the observations and findings are resolved (828). ECA 800 determines whether there is another interval (830). If so, ECA 800 goes to step 814. If not, ECA 800 stops (832).

A preferred form of the on-demand environment security service has been shown in the drawings and described above, but variations in the preferred form will be apparent to those skilled in the art. The preceding description is for illustration purposes only, and the security service should not be construed as limited to the specific form shown and described. The scope of the security service should be limited only by the language of the following claims.

What is claimed:

1. A system comprising:
a provider of an on-demand operating system where a plurality of customers share resources at a system, a subsystem and a storage level;
a plurality of resource configurations, each defined for one of the plurality of customers by the provider;
a security guide file containing a plurality of rules and a plurality of implementing procedures for system; and
a security application that monitors security in the system and that resolves an identified security incident in accordance with an instruction from the security guide file to ensure isolation of a service provider's customers.

2. The system of claim 1 wherein the security guide file further comprises: a specification of networking requirements, a specification of physical requirements, and a specification of logical requirements.

3. The system of claim 1 wherein the security application further comprises: instructions for implementation of physical security controls, instructions for implementation of network security controls, and instructions for implementation of logical security controls.

4. The system of claim 3 wherein the security application further comprises: instructions for monitoring physical security, instructions for monitoring network security, and instructions for monitoring logical security.

5. The system of claim 4 wherein the security application further comprises: instructions for deploying security updates.

6. The system of claim 5 wherein the security application further comprises: instructions for inspecting system logs and for inspecting component logs.

7. The system of claim 6 wherein the security application further comprises: instructions for performing security scans, instructions for identifying security incidents, and instructions for resolving security incidents.

8. The system of claim 7 wherein the security application further comprises: instructions for testing physical devices, instructions for testing logical devices, and instructions for testing for potential intrusions.

9. The system of claim 8 wherein the security application further comprises: instructions for evaluating potential security problems, and instructions for resolving potential security problems.

10. An on-demand environment security service to ensure isolation of a service provider's customers where the customers share resources at the system, subsystem, and storage level comprising:
prior to boarding a customer, defining a plurality of resources to be protected in a security guide, and using the security guide, planning and implementing physical segregation at the facility, network, and technical and delivery support levels; and
after boarding the customer, maintaining physical segregation by reviewing and updating the security guide, testing physical segregation by performing security audits and penetration tests, and resolving observations and findings of the audits and penetration tests.

11. The on-demand security service of claim 10 further comprising: using the security guide file, implementing physical voice controls, implementing logical voice controls, implementing logical data controls, implementing network gateway controls, and implementing mobile terminal logical access controls.

12. The on-demand security service of claim 10 further comprising: controlling access to data at the system and subsystem level by defining and classifying resources to be protected, defining and validating users that need access to a platform provided security mechanism, granting access rights, ensuring implementation of a security and integrity advisory process, ensuring that a user administration procedure meets on demand configuration security requirements, approving access based on business need, and revalidating the need for access on a periodic basis.

13. The on-demand security service of claim 10 further comprising: establishing a media inventory, establishing a media tracking file, classifying and declassifying the media as required, and providing physical protection of the media.

14. The on-demand security service of claim 10 further comprising: reviewing the security guide to ensure support is provided for a new component, reviewing the security guide to ensure that changes to support the new component are implemented, maintaining physical segregation at the facility level, performing security audits, performing penetration tests, and performing a periodic review of the security guide based on account-specific criteria.

15. The on-demand security service of claim 10 further comprising: modifying the security guide based on specific incidents, managing security incidents, performing peer and self assessments, performing systems assurance reviews, reviewing audit results, monitoring systems misuse, ensuring that incidents can be detected, creating incident and issue records, maintaining a physical access list for secure rooms and areas, interfacing with sites facilities for support of physical address control systems, making decisions regarding access requests, and performing periodic reviews and validation of physical access control systems.

16. A computer program product comprising: a security guide, a security guide application, a security implementation application, a security validation application, and an event coordination application; wherein the security guide, the security guide application, the security implementation application, the security validation application, and the event coordination application, when loaded and activated in an on-demand environment, cooperate to ensure isolation of a service provider's customers.

17. The computer program product of claim 16 further comprising: instructions for accessing the security guide for a pre-determined set of requirements, and instructions for coordinating physical segregation, network segregation, and logical segregation.

18. The computer program product of claim 16 further comprising: instructions for implementing the requirements for physical isolation of the customer, instructions for implementing the physical and logical requirements for the network, and instructions for implementing logical requirements for technical and delivery support.

19. The computer program product of claim 16 wherein the security validation application further comprises: instructions for validating the requirements for physical isolation of the customer, instructions for validating the physical and logical requirements for the network, and instructions for validating the logical requirements for technical and delivery support.

20. The computer program product of claim 16 wherein the event coordination application further comprises: instructions for accessing the security guide file, and instructions for determining whether an interval specified in the security guide file for execution of an action has elapsed.
